(19) United States
(12) Patent Application Publication
(10) Pub. No.: US 2007/0228686 A1
(43) Pub. Date: Oct. 4, 2007

(54) MOVABLE SUBFRAME FOR TRACTOR-TRAILERS

(75) Inventors: Gary E. Gerstenslager, Canton, OH (US); Phillippi R. Pierce, Canton, OH (US); Dane Gregg, Uniontown, OH (US)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(73) Assignee: HENDRICKSON USA, L.L.C., Itasca, IL (US)

(21) Appl. No.: 11/693,327

(22) Filed: Mar. 29, 2007

Related U.S. Application Data
(60) Provisional application No. 60/787,803, filed on Mar. 31, 2006.

(51) Int. Cl. B60G 7/02; B62D 53/06; B62D 21/00

(52) U.S. Cl. 280/149.2; 280/124.116; 280/124.109; 280/800

(57) ABSTRACT

A movable subframe for a tractor-trailer includes a pair of spaced-apart, parallel, elongated and longitudinally extending main members. At least two cross members extend between and are attached to the main members, and a retractable pin mechanism selectively positions the subframe beneath a body of a trailer of the tractor-trailer. The retractable pin mechanism includes only two pins, with each pin being located generally centrally along a length of a respective one of the main members of the subframe. Each pin is extendable through an opening formed in its respective main member and a selected one of a plurality of openings formed in a body rail of the trailer, so that when the pins are in an extended or locked position, the retractable pin mechanism provides generally central support for the subframe and for an axle/suspension system which depends from the subframe.

### CROSS-REFERENCE TO RELATED APPLICATION

This application claims the benefit of U.S. Provisional Patent Application Ser. No. 60/787,803, which was filed on Mar. 31, 2006.

### BACKGROUND OF THE INVENTION

1. Technical Field

The invention relates to tractor-trailer subframes, and in particular to movable subframes for tractor-trailers. More particularly, the invention is directed to a movable subframe for tractor-trailers which includes a retractable pin mechanism for locking the movable subframe in a selected position relative to the tractor-trailer body. Still mole particularly, the invention relates to a movable subframe for tractor-trailers having a retractable pin mechanism with two pins located generally centrally along the length of the subframe, for reducing the weight and cost of the subframe, for reducing or eliminating potential undesirable separation of the subframe from the tractor-trailer body, and further for reducing or eliminating potential undesirable distortion of the subframe.

2. Background Art

Heavy-duty vehicles that transport cargo, for example, tractor-trailers or semi-trailers, typically include leading or trailing arm suspension assemblies that connect the axles of the vehicle to the frame of the vehicle. In many heavy-duty vehicles, the primary frame of the vehicle supports a movable subframe, and the suspension assemblies connect directly to the subframe. Such movable subframes, typically referred to as slider boxes, slider subframes, slider undercarriages, or slider secondary frames, have been utilized on tractor-trailers or semi-trailers for many years. For purposes of clarity, hereinafter the present invention will be referred to as a slider box.

One or more axle/suspension systems usually are suspended from a single slider box. It is understood that a slider box outfitted with usually two axle/suspension systems typically is referred to as a slider or slider tandem, and again, for purposes of clarity will hereinafter be refereed to as a slider tandem. Of course, as mentioned above, a slider box may also be outfitted with a single axle/suspension system, or three or more axle/suspension systems. Reference herein shall be made to a slider tandem by way of example, with the understanding that such reference also applies to a slider outfitted with one, three or more axle/suspension systems. The slider tandem in turn is mounted on the underside of the trailer frame, and is movable longitudinally therealong to provide a means for variable load distribution and vehicular maneuverability.

More specifically, the amount of cargo that a trailer may carry is governed by local, state and/or national road and bridge laws, and is dependent on propel load distribution. The basic principle behind most road and bridge laws is to limit the maximum load that a vehicle may carry, as well as limit the maximum load that can be supported by individual axles. A trailer having a slider tandem gains an advantage with respect to laws governing maximum axle loads. Mole particularly, proper placement of the slider tandem varies individual axle loads or redistributes the trailer load so that it is within legal limits. To maintain slidable engagement of the slider tandem with the trailer, the main members of the slider box each include a rail guide mounted on the outboard surface of the main member adjacent each of its front and rear ends. The rail guides slidably engage a pair of spaced-apart rails that are mounted on and depend from the underside of the trailer body.

Once properly positioned, the slider tandem is locked in place on the underside of the trailer by a retractable pin mechanism. The retractable pin mechanism generally includes two or more, and typically four, retractable pins which may be interconnected by a crank mechanism or other mechanical means, or by hydraulic, pneumatic or electrical means. When the pins are in their extended position, they each extend through a respective opening formed in the main members of the slider box and a selected aligned one of a plurality of openings formed in the rails that are mounted on the underside of the trailer body. The pins thereby lock the slider box in a selected position relative to the trailer body.

In the prior art, retractable pin mechanisms generally include two different categories. The first category is a four-pin assembly, and the second category is a two-pin assembly. Turning first to the four-pin assembly, the assembly includes one pin located near the front end of each of the two slider box main members, and another pin located generally centrally along each of the two slider box main members, or alternatively near the rear end of each of the two main members. The four-pin assemblies of the prior art typically are mechanically operated by a crank mechanism, or can be pneumatically operated by an actuator that is pneumatically connected to the air reservoir of the vehicle, or may be hydraulically or electrically operated or actuated.

The use of four pins, however, undesirably increases the weight and cost of the slider box when compared to a two-pin assembly which is described in greater detail below. More particularly, a four-pin assembly increases the number of pins used in the retractable pin mechanism, and increases the number of components used to mount and interconnect the pins in order to provide generally simultaneous activation of the pins from a single actuator. This addition of two extra pins and mounting and interconnection components adds weight and cost to the mechanism and to the slider box that is not present in most two-pin assemblies.

Moreover, the use of four pins rather than two also creates the need to form additional openings in each main member through which the pins extend, and additional openings in certain cross members to enable interconnection between the pins located at the front of the main members and the pins located generally in the central or rear portion of the main members. Forming these additional openings in the main members and cross members may decrease the stiffness of the slider box, which in turn undesirably decreases the ability of the slider box to efficiently distribute loading forces.

Another disadvantage of a four-pin assembly is an increased possibility that one of the pins may jam. That is, as mentioned above, each pin extends through a respective opening in the wall of its respective main member and an aligned opening in the trailer body rail. As known in the art, during vehicle operation, there is a possibility that there may be slight movement of the slider box with respect to the trailer body, which may misalign the openings in the main member wall and the trailer body rail, thus potentially jamming a pin in an extended position, which reduces or prevents easy retraction of the jammed pins from the openings for repositioning of the slider tandem. By increasing the amount of pins that are used, the possibility that any one pin may become jammed thus undesirably increases.

Several of the above-described disadvantages associated with the four-pin assembly, such as increased weight, complexity and cost, may be reduced or eliminated by employing the second category of retractable pin mechanism, that is, the two-pin assembly. In the known two-pin assemblies of the prior art, each pin is located near the front end of respective ones of the two slider box main members. The two-pin assemblies of the prior art typically are mechanically operated, such as by a crank mechanism as mentioned above. However, these two-pin assemblies include structural disadvantages, which may undesirably result in potential separation of the slider box from the underside of the trailer and/or distortion of the slider box main members.

More particularly, the trailer of a tractor-trailer is sometimes placed on a flatbed railroad car for transportation. To load and unload the trailer onto and off of the railroad car, the trailer often is lifted by a lifting device as is known in the art. When the lifting device lifts the trailer, the lifting device supports the trailer body, rather than the slider tandem. As a result, when the trailer is in the air, the axle/suspension system lacks support beneath it and hangs in the air, creating a downward force on certain components that connect the slider tandem to the trailer primary frame, such as the slider box rail guides and the trailer body rails. That is, since the retractable pins are located only near the front end of the slider tandem and no pins are present in the central or rear portions of the slider tandem to provide additional support, the weight of the rear end of the slider tandem is borne solely by the interface between the rear rail guides and the trailer body rails. However, this interface typically is designed to facilitate slidable engagement of the slider tandem and the trailer rather than supporting the weight of the rear end of the slider tandem. As a result, the rail guides and/or trailer body rails may bend and thus become damaged, or the rail guides may separate from the trailer body rails, which in turn creates a separation of the rear end of the slider tandem from the trailer.

These disadvantages of prior-art two-pin assemblies may also be encountered during operation of the vehicle. For example, when the trailer travels through a dip or depression in a road, there may a period of time during which the front axle/suspension system of the slider tandem is in contact with the road, but the rear axle/suspension system is not, and thus is suspended in mid-air. Such an event also creates the above-described downward force on the rear rail guides and the trailer body rails, which may damage the rail guides and/or the trailer body rails, or may cause the rail guides to separate from the trailer body rails.

Moreover, the location of the pin near the front end of each main member in prior art two-pin assemblies is a high-stress area, which may lead to distortion or bending of the main members at the interface with the pins due to operational load forces, such as fore-aft load forces. More particularly, as the vehicle travels over-the-road, the axle/suspension system moves generally upwardly and downwardly in an arcuate manner. This motion is transmitted through hangers, which connect the axle/suspension system to the main members of the slider box, and to the slider box main members as a force and as a moment, the latter of which is the tendency of the force to cause rotation about a point. The force is transmitted along the main members to the pins, and the pins also become the point on which the moment acts. To distribute this force and moment, the main members contact the underside of the trailer body, which provides structural support for the main members. However, since the prior art pins extend through the main members near the front end of each main member, the structural support of the main members frontwardly of the pins is extremely limited. This limited structural support allows the force and the moment to potentially undesirably cause the main members to distort or bend at the point where the pins extend through the main members.

Other fore-aft load forces may be created by events such as single-wheel impacts, which are caused by a wheel striking a bump in a road, a large pot-hole, or highway guard rails. When a vehicle undergoes a single-wheel impact, a vertical force is produced which in turn produces a force in the aft direction. The force in the aft direction is transmitted through the hangers to the slider box main members as a force and as a moment, in a manner similar to that as described above. With the two-pin system of the prior art, the limited structural support of the main members frontwardly of the pins may thus again allow the force and the moment to distort or bend the main members at the point where the pins extend through the main members.

In an attempt to reduce the above-described potential damage to the main members, the main members have often been manufactured with increased wall thicknesses. However, such increased wall thicknesses undesirably increase the weight and cost of the slider box. In addition, even with increased wall thicknesses, the slider box main members may still experience damage.

As a result, a need has existed in the art to develop a slider box including a retractable pin mechanism that reduces the weight and cost of the slider box, reduces or eliminates potential undesirable separation of the slider box from the tractor-trailer body, and reduces or eliminates potential undesirable distortion of the slider box main members. The present invention satisfies this need, providing a slider box including a retractable pin mechanism that reduces the weight and cost of the slider box, reduces or eliminates potential undesirable separation of the slider box from the tractor-trailer body, and reduces or eliminates potential undesirable distortion of the slider box main members.

### SUMMARY OF THE INVENTION

One objective of the present invention is to provide a slider box having a retractable pin mechanism that reduces the weight and cost of the slider box.

Another objective of the present invention is to provide a slider, box having a retractable pin mechanism that reduces or eliminates potential undesirable separation of the slider box from the tractor-trailer body.

Yet another objective of the present invention is to provide a slider box having a retractable pin mechanism that reduces or eliminates potential undesirable distortion of the slider box main members.

These objectives and advantages are obtained by the improved movable subframe for tractor-trailers of the present invention. In an exemplary embodiment of the invention, the improved movable subframe is selectively movably mounted on a pair of rails mounted on and depending from a body of a trailer of the tractor-trailer. The subframe includes a pair of spaced-apart, parallel, elongated and longitudinally extending main members, at least two cross members that extend between and are attached to the main members, and a retractable pin mechanism for selective positioning of the subframe beneath the trailer body on the rails. The improved subframe includes a pair of pins, and each one of the pins is disposed generally centrally along a length of a respective one of the main members, and is extendable through an opening formed in its respective main member and a selected one of a plurality of openings formed in a respective one of the body rails. When the pins are in an extended position, the retractable pin mechanism provides generally central support for the subframe and for an axle/suspension system which depends from the subframe.

### BRIEF DESCRIPTION OF THE DRAWINGS

The preferred embodiment of the present invention, illustrative of the best mode in which applicants have contemplated applying the principles, is set forth in the following description and is shown in the drawings, and is particularly and distinctly pointed out and set forth in the appended claims.

FIG. 1 is a top front perspective view of a prior art slider box for a tractor-trailer, showing the retractable four-pin mechanism used to selectively position the slider box along the underside of a trailer body, and further showing depending hangers for suspending axle/suspension systems from the slider box;

FIG. 2 is an enlarged fragmentary side elevational view of a prior art slider tandem, including the prior art slider box shown in FIG. 1, and showing one of two axle/suspension systems, with hidden portions, a tire and brake components represented by broken lines;

FIG. 3 is a reduced-size fragmentary view looking in the direction of lines 3-3 of FIG. 2, with portions thereof represented by broken lines, and showing the prior art slider tandem of FIG. 2 movably mounted on the underside of a trailer body, with the front reinforcing cross member of the slider box of the slider tandem removed;

FIG. 4 is a greatly enlarged fragmentary view taken from the circled area in FIG. 3, and showing one of the pins of the retractable pin mechanism in the locked position;

FIG. 5 is a top front perspective view of a slider box for a tractor-trailer of the present invention, showing the retractable two-pin mechanism used to selectively position the slider box along the underside of a trailer body, and further showing depending hangers for suspending axle/suspension systems from the slider box; and

FIG. 6 is a greatly enlarged fragmentary top perspective view of the retractable two-pin mechanism shown in FIG. 5.

Similar numerals refer to similar parts throughout the drawings.

### DESCRIPTION OF THE PREFERRED EMBODIMENT

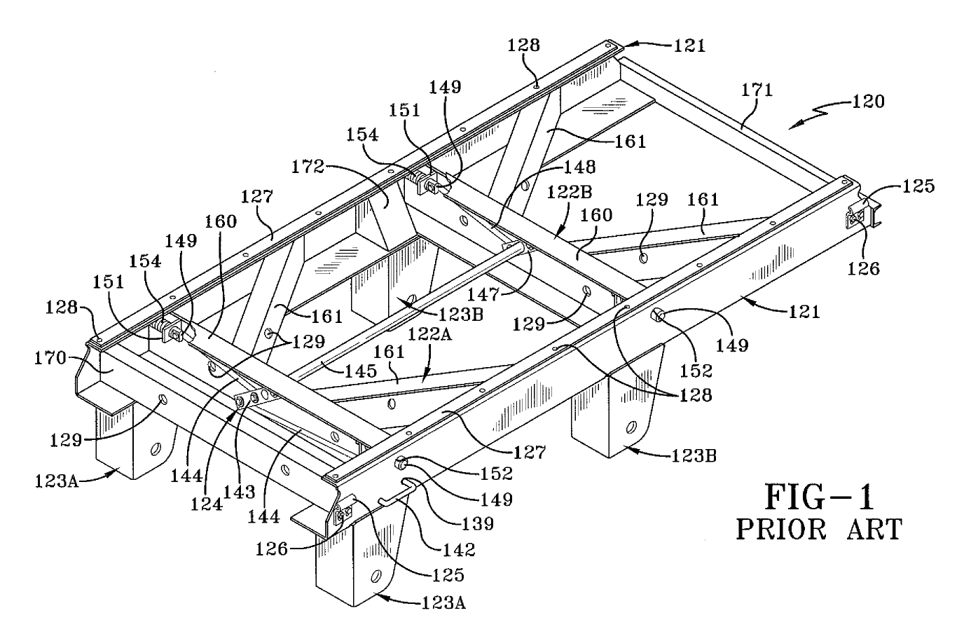

In order to better understand the slider box of the present invention, a prior art slider box for a tractor-trailer is shown in FIG. 1, is indicated generally at 120, and now will be described. Slider box 120 includes a pair of main members 121 and front and rear generally K-shaped cross member structures 122A and 122B, respectively. Front and rear pairs of hangers 123A and 123B, respectively, are attached to respective ones of main members 121 for suspending axle/suspension systems. A retractable pin mechanism 124 is incorporated into slider box 120 for selective positioning of the slider box beneath the vehicle primary frame, as will be described in greater detail below.

Reference to slider box 120 includes styles of slider boxes known in the art other than K-frame type slider boxes, such as perpendicular-frame or ladder-type slider boxes, and slider boxes suspending other types of suspension assemblies than those described and shown herein, such as spring suspensions. In addition reference to retractable pin mechanism 124 includes other types of retractable pin mechanisms known in the art, such as frontwardly disposed two-pin mechanisms that are mechanically actuated, and four-pin mechanisms that are mechanically, hydraulically, pneumatically or electrically actuated. For the sake of clarity and consistency, reference hereinbelow will be made to slider box 120 and retractable pin mechanism 124 with the understanding that such reference generally includes all types of slider boxes and pin mechanisms, respectively, known to those skilled in the art.

With continuing reference to FIG. 1, each main member 121 is a longitudinally-extending, elongated, generally C-shaped beam made of a metal such as steel or other suitable material. The open portion of each main member 121 is opposed to the open portion of the other main member and faces inboard relative to slider box 120. Main members 121 are connected to each other in a spaced-apart parallel relationship by K-shaped cross member structures 122A, B.

Each K-shaped cross member structure 122 includes a base member 160 which extends between and is perpendicular to main members 121. The open portion of each base member 160 faces in a frontward direction. Each end of base member 160 nests in the open portion of a respective one of main members 121, and is secured therein by any suitable means such as welding or mechanical fastening. Each base member 160 is a generally C-shaped beam made of a metal such as steel or other suitable material. Each front hanger 123A is attached by welding or other suitable means, to the lowermost surface of a respective one of main members 121 at a location directly beneath base member 160 of front K-shaped cross member structure 122A. Each rear hanger 123B similarly is attached at a location directly beneath base member 160 of rear K-shaped cross member structure 122B.

Each K-shaped cross member structure 122 further includes a pair of inclined, diagonal or angled members 161, each of which is a generally C-shaped beam also made of a metal such as steel or other suitable material. The open portion of each angled member 161 faces in an outboard-frontward direction, and each of the angled members extends between generally the middle portion of base member 160 and a respective one of main members 121. The front end of each angled member 161 is attached to the rearwardmost surface of base member 160 at an angle by any suitable means such as welding or mechanical fastening, and the rear end of each of the angled members is nested at an angle in the open portion of a respective one of main members 121, and also is attached thereto by any suitable manner such as welding or mechanical fastening. Thus, it can be seen that base member 160 and angled members 161 form an integral K-shaped cross member structure 122 which interconnects and maintains main members 121 in a spaced-apart parallel relationship. A reinforcing cross member 170 is disposed frontwardly of retractable pin mechanism 124, and extends between and is perpendicular to main members 121. Reinforcing cross member 170 is a generally C-shaped beam made of a metal such as steel or other suitable material, the open portion of which faces in a rearward direction. Each end of reinforcing member 170 nests in the open portion of a respective one of main members 121, and is secured therein by any suitable means such as welding or mechanical fastening. An optional reinforcement bar 171, which extends between the rearwardmost ends of main members 121, adds additional strength to the structure, and is attached thereto by any suitable means such as welding or mechanical fasteners.

One or more openings 129 are formed in the vertically extending surface of front cross member 170, each base member 160 and each angled member 161, and each of the openings 129 is aligned with the corresponding openings formed in the other members to provide for passage of air and/or fluid conduits, electrical lines, and the like used in the operation of the tractor-trailer (not shown).

Each main member 121 has a pair of tail guides 125 mounted on its outboard surface by bolts 126. Each rail guide 125 is mounted adjacent to a respective one of the ends of main member 121. A low friction strip 127 is attached to the uppermost surface of each main member 121 by recessed fasteners 128, and extends generally the entire length of main member 121. Strip 127 is formed of any suitable low friction material, such as ultra-high molecular weight polyethylene.

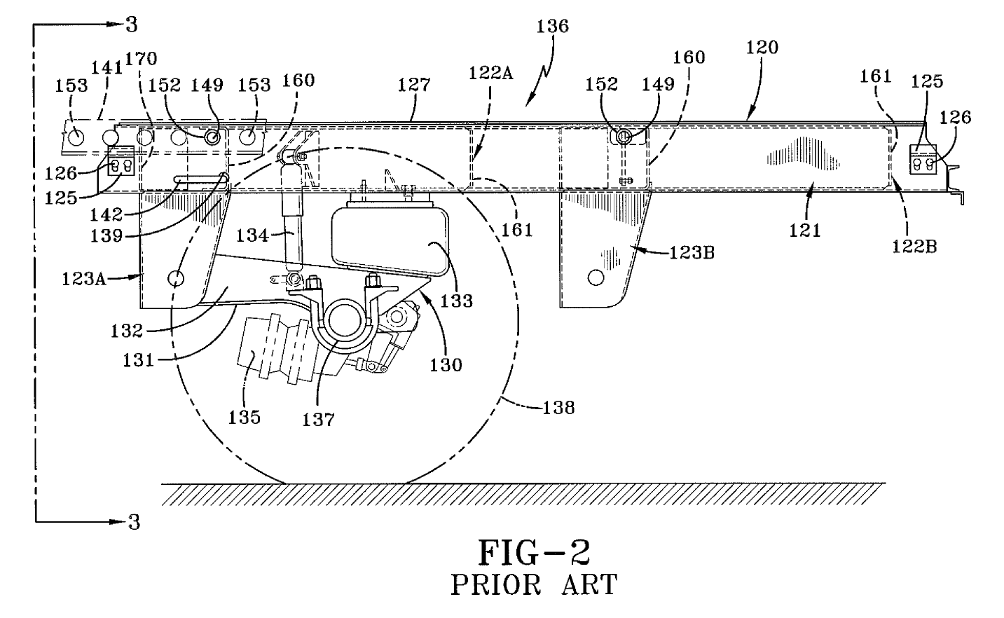

As mentioned hereinabove, and as best shown in FIG. 2, prior art slider box 120 supports front and rear axle/suspension systems, forming a slider tandem 136. However, only front axle/suspension system 130 is shown in the drawings and described herein since the front and rear systems are identical in structure and operation. Moreover, inasmuch as axle/suspension system 130 is suspended from slider box 120, but does not form an integral part thereof only the major components of the system will be cited for aiding in the description of the environment in which the prior art slider box operates.

Axle/suspension system 130 includes generally identical suspension assemblies 131 suspended from each hanger 123A of the pair of front hangers. Each suspension assembly 131 includes a suspension beam 132 which is pivotally mounted on hanger 123A in a usual manner. An air spring 133 is suitably mounted on and extends between the upper surface of the rearwardmost end of suspension beam 132 and main member 121 at a location directly beneath the outboard end of a respective one of angled members 161 of K-shaped cross member structure 122A. A shock absorber 134 extends between and is mounted on suspension beam 132 and the respective angled member 161. Another component of suspension assembly 1331, mentioned herein only for the sake of relative completeness, is an air brake 135. An axle 137 extends between and is captured in the pair of suspension beams 132 of axle/suspension system 130. One or more wheels 138 are mounted on each end of axle 137. A reinforcement member 172 (FIG. 1) is mounted by any suitable means in the open portion of each main member 121 frontwardly of and adjacent to each end of rearward base member 160 and directly above rearward hanger 123B, to provide additional strength to slider box 120 for supporting the rearward hanger and its associated suspension assembly.

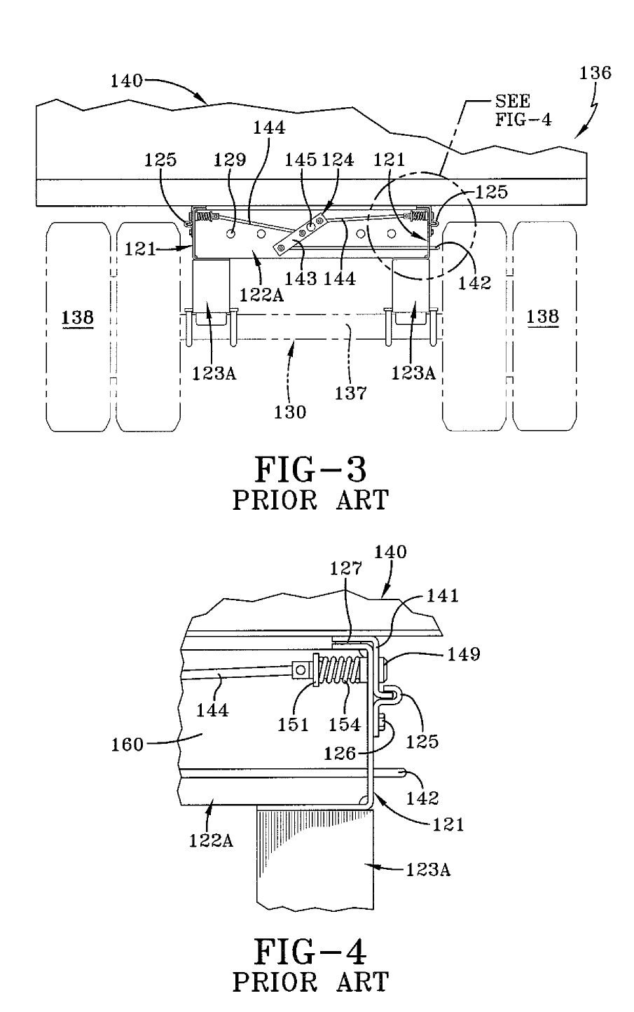

Slider tandem 136 is movably mounted on the trailer body 140 (FIGS. 3-4) by slidable engagement of rail guides 125 with spaced apart, parallel and generally Z-shaped rails 141, which are mounted on and depend from the underside of the trailer body. Each low friction strip 127 abuts the bottom surface of the uppermost portion of a respective one of rails 141 to provide a smooth, generally friction-free contact surface for slidable movement of slider tandem 136 on trailer body 140.

Slider tandem 136 can be selectively positioned relative to trailer body 140 for optimum load distribution by retractable pin mechanism 124. As best shown in FIGS. 1 and 3, pin mechanism 124 includes a generally L-shaped handle 142 which passes through an opening 139 formed in a selected one of main members 121, but usually on the driver's side of the tractor trailer. It can be seen that the bent end portion of handle 142, which extends outwardly from the outboard side of main member 121, is accessible for easy grasping by an operator of the tractor-trailer. The inboard end of handle 142 is pivotally attached to a level 143, which in turn is pivotally attached to a pair of arms 144 which extend in opposite outboard directions from lever 143. Level 143 further is attached to an elongated pivot rod 145 which passes rearwardly through an opening (not shown) formed in base member 160 of front K-shaped cross member structure 122A. The end of pivot rod 145 remote from lever 143 similarly is attached to a remote lever 147, which in turn is pivotally attached to a pair of arms 148 which extend in opposite outboard directions from lever 147. The outboard end of each of aims 144, 148 is bent and is pivotally attached to the inboard end of a pin 149.

Referring now to FIGS. 1 and 4, the inboard end of each pin 149 is slidably mounted in an opening (not shown) formed in a bracket 151 which is attached by suitable means such as welding to a respective one of base members 160. The enlarged outboard end of each pin 149 passes through a generally round or circular-shaped opening 152 (FIG. 2) formed in a respective one of main members 121. When it is desired to lock slider tandem 136 in a selected position relative to trailer body 140, the slider box main member openings 152 are aligned with selected ones of a plurality of correspondingly-sized and shaped openings 153 formed in rails 141 of the trailer body (FIG. 2). Each pin 149 automatically extends through the selected aligned openings 152, 153 since the pin is biased in an outboard direction by a coil spring 154 captured between bracket 151 and the enlarged outboard end of pin 149. When it is again desired by the operator of the tractor-trailer to move slider tandem 136 beneath trailer body 140, the parking brake of the trailer is engaged, handle 142 is pulled in an outboard direction to retract pins 149 out of trailer tail openings 153, and slider tandem 136 is moved longitudinally along trailer rails 141 until slider box main member openings 152 align with selected trailer tail openings 153 and pins 149 engage therewith as described hereinabove for maximizing load distribution.

Although the described prior art slider box 120 satisfactorily performs its intended function, the use of four pins 152 undesirably increases the weight and cost of the slider box. In addition, particularly for prior-art slider boxes using only two pins that are located adjacent the front end of the slider box main members, loading and unloading of the trailer onto and off of a railroad car, and certain operational conditions, cause the axle/suspension system to be suspended in mid-air, which thereby causes the weight of the rear end of the slider tandem to be borne solely by the interface between the rear rail guides and the trailer body rails. This in turn may cause the rear rail guides and/or trailer body rails to bend, or may cause the rail guides to separate from the trailer body rails. Moreover; the location of the pins near the front end of the main members, where structural support is limited, may lead to distortion or bending of the main members at the interface with the pins due to fore-aft load forces that occur during vehicle operation.

As a result, a need has existed in the art to develop a slider box including a retractable pin mechanism that reduces the weight and cost of the slider box, reduces or eliminates potential undesirable separation of the slider box from the tractor-trailer body, and reduces or eliminates potential undesirable distortion of the slider box main members. The present invention satisfies this need, providing a slider box having a retractable pin mechanism with two pins located generally centrally along the length of the slider box, which reduces the weight and cost of the slider box, reduces or eliminates potential undesirable separation of the slider box from the tractor-trailer body, and reduces or eliminates potential undesirable distortion of the slider box main members.

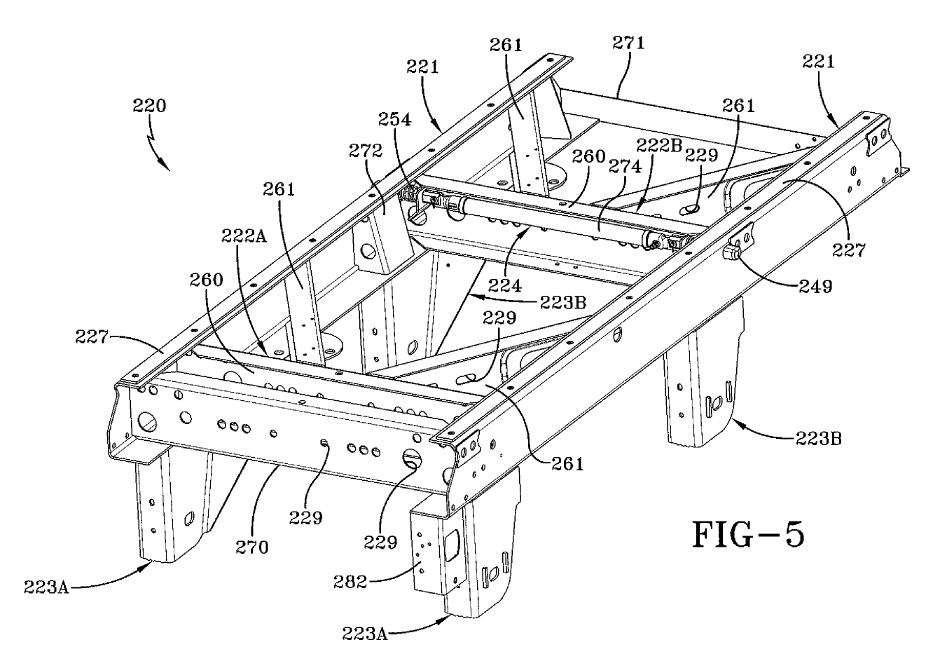

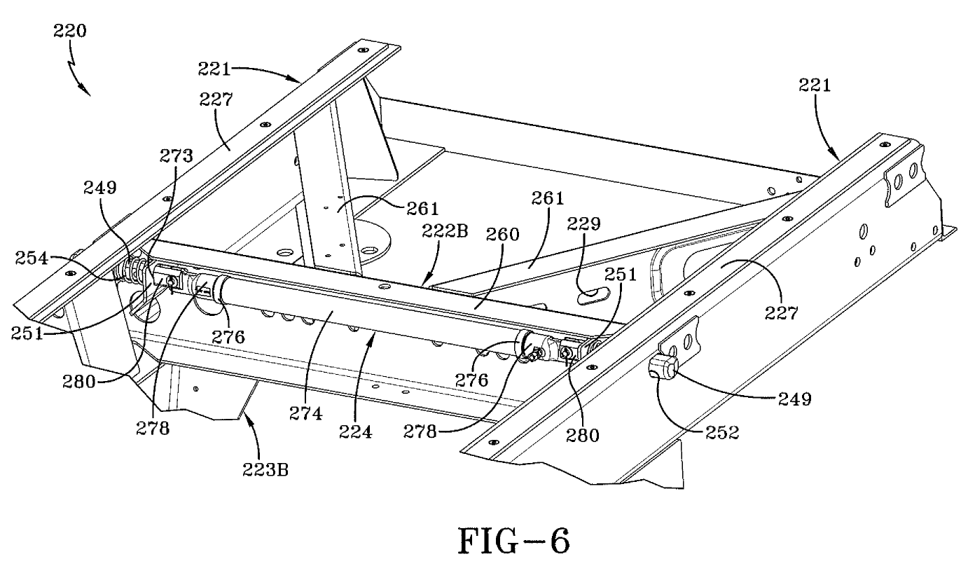

As will be described in greater detail immediately below, the present invention contemplates a slider box with components similar to those of any of the various prior art slider boxes, including slider box 120 shown in FIGS. 1-4, with the main difference being a retractable pin mechanism with only two pins located generally centrally along the length of the slider box or in a generally central portion of the slider box that includes about the central one-third of the total slider box length, which reduces the weight and cost of the slider box, reduces or eliminates potential undesirable separation of the slider box from the tractor-trailer body, and reduces or eliminates potential undesirable distortion of the slider box main members. Turning now to the drawings of the present invention, wherein the illustrations are for showing a preferred embodiment of the invention, and not for limiting the same, FIGS. 5 and 6 show a slider box of the present invention, indicated generally at 220. Only the differences between slider box 220 of the present invention and prior art slider box 120 now will be described in detail.

Slider box 220 of the present invention includes a pair of main members 221 and front and rear generally K-shaped cross member structures 222A and 222B, respectively. Front and rear pairs of hangers 223A and 223B, respectively, are attached to respective ones of main members 221 for suspending axle/suspension systems. Each K-shaped cross member structure 222 includes a base member 260 which extends between and is perpendicular to main members 221, and a pair of inclined, diagonal or angled members 261. A reinforcing cross member 270 is disposed frontwardly of front K-shaped cross member structure 222A, and extends between and is perpendicular to main members 221. An optional reinforcement bar 271 extends between the rearwardmost ends of main members 221. A reinforcement member 272 preferably is mounted by any suitable means in the open portion of each main member 221 frontwardly of and adjacent to each end of rearward base member 260 and directly above rearward hanger 223B. The structure, interconnection and operation of main members 221, cross member structures 222A,B, hangers 223A,B, reinforcing cross member 270, reinforcement bar 271 and reinforcement member 272 are generally the same as described above for prior art slider box 120.

Each main member 221 has a pair of rail guides (not shown), each one of which is mounted adjacent each respective main member end on its outboard surface by mechanical fasteners such as bolts. A low friction strip 227, which is formed of any suitable low friction material, such as ultra-high molecular weight polyethylene, is attached to the uppermost surface of each main member 221 by recessed fasteners (not shown) or by a channel (not shown) that is formed in the main members, with which the low friction strip interlocks. One or more openings 229 are formed in the vertically extending surface of front cross member 270, each base member 260 and each angled member 261, and each of the openings 229 is aligned with the corresponding openings formed in the other members to provide for passage of air and/or fluid conduits, electrical lines, and the like used in the operation of the tractor-trailer (not shown).

Slider box 220 of the present invention also includes a retractable pin mechanism 224 for selective positioning of the slider box beneath the vehicle primary frame. In accordance with one of the main features of the present invention, pin mechanism 224 includes only two pins 249, each one of which is disposed generally in a central portion of its respective main member 221. Preferably, each pin 249 is disposed in a central one-third portion of the length of its respective main member 221. Most preferably, pins 249 are located adjacent to base member 260 of rear K-shaped cross member structure 222B. As best shown in FIG. 6, the inboard end of each pin 249 is slidably mounted in an opening 273 formed in a bracket 251 which is attached by suitable means such as welding to base member 260 of rear cross member structure 222B. An enlarged outboard end of each pin 249 passes through an opening 252 formed in a respective one of main members 221. It should be noted that each pin 249 and respective opening 252 preferably are generally D-shaped, as more fully described in U.S. patent application Ser. No. 11/476,486, filed on Jun. 28, 2006, and assigned to the same assignee as the present invention, Hendrickson USA, L.L.C. Alternatively, each pin 249 and respective opening 252 may be round, as known in the art.

When it is desired to lock slider box 220 in a selected position relative to trailer body 140 (FIG. 3), slider box main member openings 252 are aligned with selected ones of a plurality of correspondingly-sized and shaped openings 153 (FIG. 2) formed in rails 141 of trailer body 140. Each pin 249 automatically extends through the selected aligned openings 252, 153 since the pin is biased in an outboard direction by a coil spring 254 captured between bracket 251 and the enlarged outboard end of pin 249. When it is desired by the operator of the tractor-trailer to move slider box 220 relative to the trailer body 140, the parking brake of the trailer is engaged, and pins 249 are retracted.

Retractable pin mechanism 224 controls the retraction of pins 249 and preferably is pneumatically actuated. The pneumatic actuation feature of retractable pin mechanism is more fully described in U.S. Pat. No. 6,279,933, which issued on Aug. 28, 2001 and is owned by the same assignee as the present invention, Hendrickson USA, L.L.C. To generally summarize, an elastomeric, elongated bladder 274 is mounted transversely between pins 249. Bladder 274 communicates with the air reservoir of the heavy-duty vehicle brake system through a pneumatic conduit (not shown). Each end of bladder 274 is operatively attached to the inboard end of a respective one of pins 249. More particularly, each one of a pair of extension members 278 is attached to a respective one of a pair of end collar is 276 of bladder 274 by a suitable connection, such as by crimping or mechanical fasteners. Each extension member 278 in turn is pivotally connected to an inboard base 280 of its respective pin 249.

With continuing reference to FIG. 6, when air is exhausted from bladder 274, the bladder is in its normal or collapsed state. The effective transverse length of bladder 274 and extension members 278 is greatest when the bladder is in the collapsed state, and so provides slack for coil springs 254 to automatically bias pins 249 outboardly and through their respective main member openings 252, and into selected aligned trailer frame rail openings 153 (FIG. 2). To retract pins 249 and reposition slider box 220, a valve (not shown) preferably is located in the pneumatic conduit between bladder 274 and the vehicle air reservoir, enabling air from the reservoir to fill bladder 274 when the valve is opened. The valve may be controlled electronically, such as by an electronic switch that is mounted in the cab of the heavy-duty vehicle, or that is disposed in a switch housing 282 mounted on slider box drivers side main rail 221 or depending driver's side front or rear hangers 223A,B. The valve may also be controlled manually, in which case a valve handle preferably is operatively mounted in an accessible location on the driver's side of the trailer (not shown).

As bladder 274 fills with air, the bladder distends and its diameter increases, and the transverse length of the bladder shortens to impart a linear pulling or retraction force on pins 249. This retraction force overcomes the bias force of springs 254 and retracts each pin 249 from its respective aligned trailer frame rail opening 153 (FIG. 2), thereby enabling slider box 220 to be selectively longitudinally repositioned beneath trailer body 140 (FIG. 3). When the position of slider box 220 relative to trailer body 140 has been selected, the valve then is closed and air is exhausted from bladder 274, thereby adding transverse slack to the bladder, in turn enabling pins 249 to automatically move to a locked position as shown in FIG. 6 due to the outboard bias of coil springs 254. It should be noted that, alternatively, locking pin mechanism 224 could be hydraulically, electrically or even manually actuated.

In this manner, centrally-disposed pneumatic locking pin mechanism 224 of slider box 220 of the present invention is a two-pin assembly that is positioned to reduce or eliminate potential undesirable separation of the slider box from the tractor-trailer body. More particularly, for prior-art slider boxes using only two pins that are located adjacent the front end of each slider box main member, loading and unloading of the trailer onto and off of a railroad car, and certain operational conditions such as traveling through a depression in the road, cause the axle/suspension system to be suspended in mid-air, which in turn causes the interface between the tear rail guides and the trailer body tails to beat the weight of substantially all of the tear end of the slider tandem. Because the rear rail guides and trailer body rails typically cannot support this weight, the rail guides and/or trailer body rails may bend and thus become damaged, or the rail guides may separate from the trailer body rails, which in turn creates a separation of the rear and of the slider tandem from the trailer.

In contrast, when a heavy-duty vehicle including slider box 220 of the present invention is lifted to be placed on a railroad car. Or encounters operational conditions that cause the rear axle/suspension system to be suspended in mid-air, the position of pins 249 in the generally longitudinal central area of each respective main member 221 provides central support of the slider tandem, which reduces the weight imposed on the rear rail guides and trailer body rails. That is, the generally central position of pins 249 more evenly distributes the weight of the hanging axle/suspension system(s) along the length of slider box main members 221 and between the front and rear rail guides, thereby reducing the weight borne by the rear rail guides when compared to a slider box using two-pin assemblies of the prior art. Reduction of the weight imposed on the rear rail guides and the trailer body rails thereby reduces or eliminates the potential for the tail guides and/or trailer body rails to bend or become damaged, and also reduces or eliminates the potential for the slider box rail guides to disengage or separate from the trailer body rails. Slider box 220 having centrally-disposed pins 249 also improves the ability of the slider box to reduce or eliminate potential undesirable distortion of the slider box main members due to operational load forces, such as fore-aft load forces. More particularly, as described above, as the vehicle travels over-the-road, the axle/suspension system moves generally upwardly and downwardly in an arcuate manner; and this motion is transmitted though hangers 223A,B to slider box main members 221 as a force and as a moment. The force is transmitted along main members 221 to pins 249, and the pins also become the point on which the moment acts. In addition, aft load forces may be created by single-wheel impacts, which also are transmitted through hangers 223A,B, to slider box main members 221 and in turn to pins 249.

For prior-art slider boxes using only two pins that are located adjacent the front ends of the slider box main members, the limited structural support of the main members frontwardly of the pins allows the force and the moment to potentially undesirably cause the main members to distort or bend at the point where the pins extend through the main members. In contrast, the position of pins 249 in generally the central third of each respective main member 221 enables optimum support of slider box 220 of the present invention. That is, main members 221 contact the underside of the trailer body for a substantial distance forwardly and rearwardly of pins 249 and respective pin openings 252, which provides structural support for the main members to distribute the force and the moment created by load forces. The generally central position of pins 249 therefore is a supported and thus lower-stress location which reduces or eliminates the potential of main members 221 to distort or bend at pin openings 252 in response to operational load forces.

Such reduced potential distortion of the slider box main members enables main members 221 of slider box 220 to eliminate certain measures used in prior art slider boxes, particularly those having two-pin assemblies of the prior art, which were used to compensate for the reduced ability of such prior art slider boxes to minimize main member distortion. For example, the wall thickness of each main member 221 of slider box 220 of the present invention preferably is thinner than that of prior art main members 121, which desirably decreases the weight and cost of the slider box.

Moreover, the use of two pins 249 in slider box 220 of the present invention also desirably reduces the weight and cost of the slider box when compared to prior-art slider box 120, which uses four pins 149. More particularly, the use of only two pins 249 in slider box 220 of the present invention reduces by half the weight and cost of pins 149 used in prior-art slider box 120. In addition, components to mount and interconnect front and rear sets of pins 149 of prior-art slider box 120, such as pivot rod 145, are eliminated, thereby adding the weight and cost savings of slider box 220 of the present invention. The use of fewer pins 249 also reduces the potential for any one pin to undesirably become jammed in an extended position.

The use of two centrally-located pins 249 in slider box 220 of the present invention also eliminates the need to form openings 153 near the front of each main member 221, as in prior art slider box 120, and reduces the need to form additional openings 229 in base member 260 of cross member structures 222A,B and in front reinforcing member 270 to provide for the interconnection of front and rear sets of pins 149, as in the prior art. Moreover, openings 229 in inclined members 261 of cross member structures 222A,B that provide for the interconnection of front and rear sets of prior art pins 149 may be eliminated. By reducing the number of openings formed in main members 221, base member 260 of cross member structures 222A,B and front reinforcing member 270, and eliminating certain openings 229 formed in inclined members 261 of cross member structures 222A,B, the stiffness of slider box 220 of the present invention is increased, which in turn desirably increases the ability of the slider box to efficiently distribute loading forces when compared to prior art slider box 120.

Thus, in this manner, the generally central position of pins 249 relative to main members 221 provides central support for slider box 220 of the present invention. For example, the generally central position of pins 249 provides central support of slider box 220 to more evenly distribute the weight of a hanging axle/suspension system along the length of slider box main members 221, such as during transfer of a trailer to a railroad car. The generally central position of pins 249 also provides central structural support for main members 221 by creating a substantial distance forwardly and rearwardly of the pins to distribute the force and the moment created by load forces during vehicle operation.

It is understood that the present invention finds application in all types of slider boxes known to those skilled in the art, including, for example, K-frame slider boxes 120 (FIG. 1), perpendicular-flame slider boxes, and slider boxes having spring suspension systems, or other types of suspension systems than those shown and described herein and known to those skilled in the art, without affecting the concept or operation of the invention. In addition, the present invention applies to slider boxes that are capable of being outfitted with one, two, three or more axle/suspension systems. The present invention also applies to slider boxes using components made from materials such as steel and other ferrous metals, nonferrous metals and alloys thereof, and composite materials. Moreover; the present invention may utilize a pin actuation system other than that described above, such as other pneumatic systems, or mechanical, hydraulic, or electrical actuation systems, which are known to those skilled in the art.

Accordingly, the improved movable subframe for tractor-trailers is simplified, provides an effective, safe, inexpensive, and efficient structure which achieves all the enumerated objectives, provides for eliminating difficulties encountered with prior art movable subframes for tractor-trailer'trailers, and solves problems and obtains new results in the art.

In the foregoing description, certain terms have been used for brevity, clarity and understanding; but no unnecessary limitations are to be implied therefrom beyond the requirements of the prior art, because such terms are used for descriptive purposes and are intended to be broadly construed. Moreover; the present invention has been described with reference to an exemplary embodiment. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the improved movable subframe for tractor-trailers is constructed, arranged and used, the characteristics of the construction and arrangement, and the advantageous, new and useful results obtained; the new and useful structures, devices, elements, arrangements, parts and combinations are set forth in the appended claims.

What is claimed is:

1. An improved movable subframe for a tractor-trailer, said subframe being selectively movably mounted on a pair of rails mounted on and depending from a body of a trailer of said tractor-trailer, the subframe including a pair of spaced-apart, parallel, elongated and longitudinally extending main members, at least two cross members extending between and being attached to said main members, and a retractable pin mechanism for selective positioning of said subframe beneath said trailer body on said rails, the improvement consisting essentially of
a pair of pins, each one of said pins being disposed generally centrally along a length of a respective one of said main members, each one of said pins being extendable through an opening formed in its respective main member and a selected one of a plurality of openings formed in a respective one of said body rails, whereby said retractable pin mechanism provides generally central support for said subframe and for an axle/suspension system depending from the subframe when said pins are in an extended position.

2. The improved movable subframe for a tractor-trailer of claim 1, wherein each said pin is located in a central one-third portion of length of a respective one of said main members.

3. The improved movable subframe for a tractor-trailer of claim 1, wherein each said pin is located adjacent one of said cross members.

4. The improved movable subframe for a tractor-trailer of claim 1, wherein said retractable pin mechanism is pneumatically actuated.

5. The improved movable subframe for a tractor-trailer of claim 1, wherein each said pin includes a D-shaped cross section.

6. The improved movable subframe for a tractor-trailer of claim 1, wherein each said pin includes a round cross section.
